(19) United States
(12) Patent Application Publication
(10) Pub. No.: US 2005/0086695 A1
(43) Pub. Date: Apr. 21, 2005

(54) Digital media presentation system

(76) Inventors: Robert Keele, Memphis, TN (US); David Trotter, Memphis, TN (US); Craig Mattson, San Francisco, CA (US)

Correspondence Address: Edmund J. Walsh;Wolf, Greenfield & Sacks, P.C., 600 Atlantic Avenue, Boston, MA, 02210-2206, US

(21) Appl. No.: 10/967,769

(22) Filed: Oct. 18, 2004

Related U.S. Application Data
(60) Provisional application No. 60/512,114, filed on Oct. 17, 2003.

(51) Int. Cl. H04N 5/445; H04N 7/16; H04N 7/173; H04N 7/18; G06F 13/00; G06F 3/00; G06F 17/00; G06F 15/00

(52) U.S. Cl. 725/86; 725/39; 725/52; 725/37; 715/500.1; 725/74; 725/129; 725/105

(57) ABSTRACT

A digital media presentation system suitable for use in providing digital signage or similar types of advertising. A video display system is used as an example of a digital media presentation system. The system includes a server that provides a user interface. Through the interface, a user may specify a schedule of assets to be executed on video display units. Execution of assets may result in display of video information in one or more windows on the video display units. Execution of assets may be synchronized within the windows and the information in each window may be coordinated to provide significant flexibility in display of information through the video display system. Application of the invention more generally to digital media presentation systems is also described, using examples of systems that integrate audio and visual information.

### RELATED APPLICATIONS

This application claims priority under 35 U.S.C. § 119(e) to U.S. Provisional Application Ser. No. 60/512,114, entitled “VIDEO DISPLAY SYSTEM,” filed on Oct. 17, 2003, which is hereby incorporated by reference in its entirety.

### BACKGROUND OF INVENTION

1. Field of Invention

This invention relates generally to digital media presentation systems and more particularly to digital media presentation systems having programmable content.

2. Discussion of Related Art

It is known to have digital media presentation systems, such as video display systems in which content may be programmed. For example, many cable companies provide “video on demand” or other similar features.

It is also known to provide video advertising through point of sale displays and similar units. Existing systems provide content to the video display units in a multiplicity of ways. Many systems have a prerecorded video loop that is played continuously. The video loop may be recorded on some moveable recording media, such as a digital video disk (DVD). As new video loops are created, multiple copies of the movable media are created and distributed to each video display unit. The media is then installed in each video display unit.

Some systems have eliminated the need to physically ship movable recording media to each display unit by providing updated content to each video display unit over a network. For example, updated video loops may be provided to video display units over a wide area network (WAN) employing satellite transmissions.

Some video display systems have touch screens that allow a user to control what information is displayed.

It would be desirable to provide an improved digital media presentation system.

### SUMMARY OF INVENTION

In one aspect, the invention relates to a digital media presentation system in which video display units receive video images as clips in conjunction with scheduling information, indicating the timing and/or sequence in which the video clips should be presented on the display.

In some embodiments, video display units have a plurality of windows, with video clips and scheduling information being provided for each window. In some embodiments, the scheduling information for video clips in each window is independent. In other embodiments, the scheduling information for video clips in each window is synchronized.

In some embodiments, the video clips and scheduling information are provided from a server to display units in one or more locations. Each location may contain one or more video display units connected to the server by a network. In some embodiments, the display units at each location are connected to a local area network, which may be addressed as a subnet of a larger network. In some embodiments, each location is a retail location of an organization.

In some embodiments, each location includes a cache server that receives video information from the server and provides it to each display unit at the location.

In one embodiment, the server is coupled to a work station through which a human operator may specify video information to be displayed and provide scheduling information for each display unit. Video information may be specified in one of multiple ways, such as graphics files, text to be displayed as a ticker, as an executable file or in any other suitable manner.

In some embodiments, the server is an interconnection of servers and databases, including an interface server that manages interactions with human users, a media server that stores media and a database server that stores information about scheduling or displayed video.

In one embodiment, the server is located at a central location and connected over a wide area network to a local area network having a plurality of display units. The server may alternatively be connected to a plurality of display units over a local area network.

In another aspect, the invention relates to a video display unit adapted for displaying video information according to a schedule. The video display unit has a screen, a processor and storage for storing video clips and schedule information. The processor is programmed to display video clips in accordance with the schedule information.

In some embodiments, the video display units are adapted to be networked, allowing one video display unit to act as a master to synchronize operations of other video display units.

In other embodiments, each display unit is programmed to generate a log of assets displayed. Each display unit periodically writes the log file to a server, where the information is used for billing or other analysis.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a digital media presentation system;

FIG. 2 is a block diagram of an alternative embodiment of a digital media presentation system;

FIG. 3 is a sketch of a video display which may be used in the digital media presentation systems of FIGS. 1 and 2;

FIG. 4A is a sketch of a user interface to the digital media presentation systems of FIGS. 1 and 2;

FIG. 4B-4F are sketches of user interfaces for wizards that may be used in connection with the user interface of FIG. 4A;

FIG. 5 is a sketch of an alternative embodiment of a video display unit;

FIG. 6 is a block diagram of the video display unit of FIG. 5;

FIG. 7 is a flow chart illustrating the operation of the video display unit of FIG. 5;

FIG. 8 is an exploded view of the video display unit 300 of FIG. 3;

FIG. 9 is a sketch of a user interface for pairing assets; and

FIGS. 10A and 10B are sketches of user interfaces for scheduling segments.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

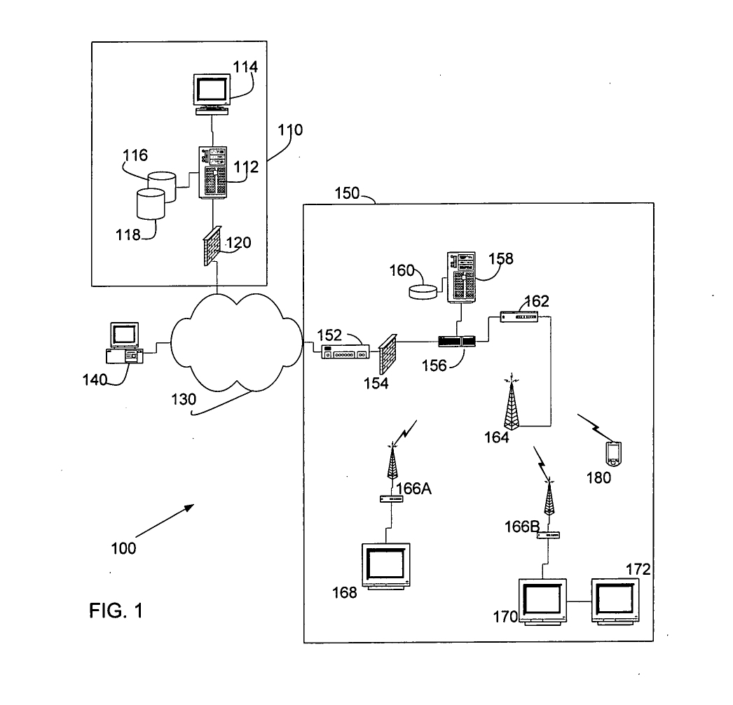

FIG. 1 is a block diagram of a digital media presentation system. A digital media presentation system may present information in digital form to a human. A digital media presentation system may, for example, display visual information and/or audio information. Here, a video display system 100 is used as an example of a digital media presentation system, but the invention is not limited to display of video information.

Video display system 100 includes components at a central location 110 and a retail location 150. Retail location 150 may be a retail store, a shopping mall, an amusement park or any location or a group of locations at which a user of the video display system 100 may wish to present video information. Video information may include text, graphics, still photos, slide shows, animations, movie clips or any other information that can be displayed visually. Video information may optionally be accompanied by audio information.

In system 100, central location 110 is linked to retail location 150 through a wide area network 130. In this example, wide area network 130 represents the Internet. As one example, central location 110 may be the company headquarters for the company that operates retail location 150. However, central location 110 need not be operated by the same entity that operates retail location 150. In some embodiments, central location 110 is operated by a third party service provider that provides video content management for the enterprise operating retail location 150.

Retail location 150 includes, in this example, multiple display units 168, 170, and 172. Display units 168, 170 and 172 display video information of interest to people in retail location 150. As described in greater detail below, video display system 100 provides a convenient and flexible way to schedule the display of information on each of the display units 168, 170 and 172. Here, three display units are shown. This number of units is shown for simplicity. Any number of display units may be used at retail location 150. Where retail location 150 spans a relatively large area, such as a shopping mall or an amusement park, hundreds of display units may be included in the video display system.

In the example of FIG. 1, central location 110 includes a server 112. Server 112 may consist of any suitable computer hardware programmed with any suitable software. In a specific example, server 112 is an Intel® based server operating under the Linux operating system and running an Oracle® database. In this example, server 112 is acting as a user interface server as well as a content distribution server.

Databases 116 and 118 are connected to server 112. Database 116 in this example is a media database. It stores video information that may be presented on display units 168, 170, and 172. In the described embodiments, media is stored as digital files in database 116. Media may be stored in any suitable file format. In the examples given below, video media is stored in a standard file format such as MPEG, Flash, GIF, or JPG.

Database 118 is a scheduling database. It stores information about the display units such as 168, 170, and 172. It also stores “playlists” for each of the video display units. Each playlist identifies a schedule of “assets” to be processed by a display unit.

An asset may be a video clip stored in media database 116. More generally, an asset may be any object that may be executed by a display unit. Video files may be thought of as executable objects, with execution of the object causing video information to appear on the screen of the display unit. In other embodiments in which audio or other types of information is presented, assets may encode audio or other types of information.

In one contemplated embodiment, the playlist is represented by an XML document. In this embodiment, an asset may be any object that can be accessed from an XML document, such as a PERL script or a J2EE web application with an XML interface. Such assets may impact the display on a display unit such as 168, 170 or 172. However, such assets need not impact the information displayed visually by the display unit. Such assets could, for example, cause the video display unit to perform a self test, check for user input, provide information to other display units, provide information to a server such as 112, retrieve information from a cache server or perform any other automated task.

Scheduling database 118 may store more than one schedule for each display unit. The display screen on each video display unit may be segmented into multiple windows, with a separate playlist for each window. In addition, a video display unit may have one ore more playlists that cause the execution of assets that do not impact the information on a display screen associated with that display unit.

Scheduling database 118 may also store data gathered from display units at a retail location 150 indicating what content was displayed. For example, display units such as 168, 170 and 172 may display advertisements for which the operator of retail location 150 charges a royalty to display. The display units 168, 170, and 172 may send information on actual content displayed to server 112 which would then create a record in database 118. Records of content displayed may be provided to server 112 directly or may be collected by cache server 158 where they can be periodically pushed to server 112 or periodically read by server 112. As an example, records of actual content displayed may be used to compute royalties due the operator of retail location 150 for displaying advertisements in retail location 150 or to compute royalties owed to the creators of content displayed when assets are executed.

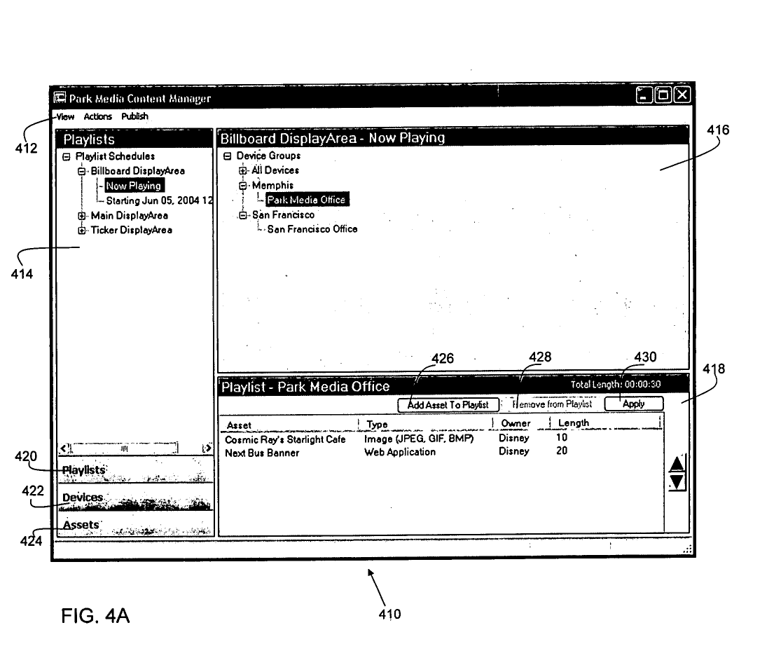

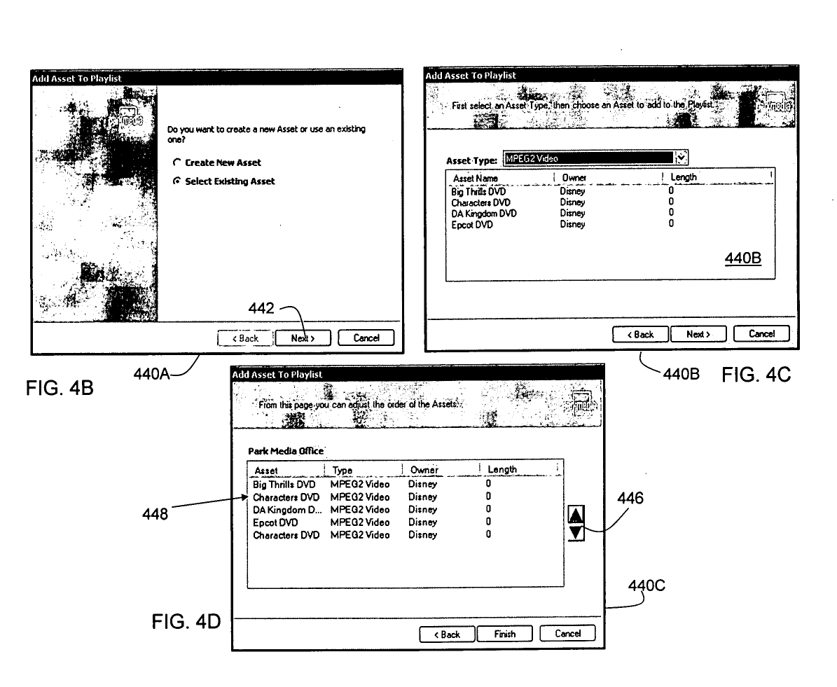

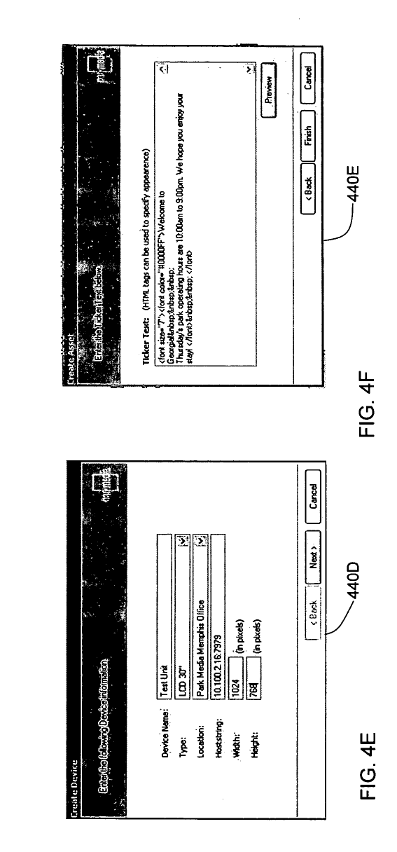

Central location 110 also includes an operator terminal 114. As in a conventional server, operator terminal 114 provides a user interface to allow a user to enter programs or data into server 112. As described below in connection with FIG. 4, operator terminal 114 provides a user interface allowing a user to schedule content to be displayed on each of the display units.

In the example of FIG. 1, server 112 is connected through a router/fire wall 120 to the Internet 130. Retail location 150 is also connected to the Internet 130. In this example, retail location 150 is connected through a modem 152 to Internet 130. Retail location 150 may be connected to the Internet 130 through any suitable connection. For example, a cable or DSL connection may be used. Preferably, modem 152 is compatible with whichever type of connection to the Internet is provided.

Modem 152 is connected to a router/firewall 154. Router/firewall 154 is connected to switch 156. Switch 156 makes connections to computerized components in retail location 150. In this embodiment, the computerized components within retail location 150 are connected in a local area network. Any suitable media may be used to implement the local area network. In the embodiment of FIG. 1, a wireless network is used. However, the network may be implemented with fiber optics, CAT-5 wiring or other cabling.

Server 158 is connected through switch 156 into the local area network. Server 158 may be an Intel® based server as is known in the art. In the illustrated embodiment, server 158 acts as a cache server. Database 160 is connected through cache server 158. In the network configuration illustrated in FIG. 1, cache server 158 receives media and schedule information from server 112. This information is stored in database 160.

Cache server 158 is connected through switch 156 to bridge 162. Bridge 162 connects wireless access point 164 to the local area network within retail location 150. In this way, devices within retail location 150 may be connected to other device on the local area network, such as cache server 158, without the need for special wiring.

Providing a cache server such as 158 within retail location 150 reduces the amount of information that must pass through modem 152 and also reduces the amount of information that must be transmitted by server 112. Such a configuration can speed the operation of the overall system 100, particularly as new assets are programmed into display units such as 168, 170 and 172. However, this construction is not required. Server 112 could communicate directly with each display unit.

The information provided to cache server 158 is specified by the scheduling of assets in the video display system 100. In one embodiment, a human user interacts with server 112 to specify a schedule of assets for each display unit. This information is recorded as a playlist for each video display device. In the embodiment of FIG. 1, once a user specifies a playlist, it may be “published” to all devices executing that playlist. As part of the publication process, server 112 transmits a copy of the playlist. Assets to be executed as part of the playlist that are not stored in the display unit may also be transmitted when the playlist is “published.” Where a cache server such as 158 is used, the information is first stored in the cache server.

Information is provided from cache server 158 to each of the display units such as 168 and 170. Information may be pushed to the display units or may be pulled by the display units. In one embodiment, each display unit periodically queries cache server 158 to ascertain whether cache server 158 stores new assets or new scheduled information.

The assets in each display unit such as 168 and 170 may be “synchronized” to the assets in cache server 158. Synchronization of data files on two computers is known in the art. Any suitable method for synchronizing the information stored in the computer of display unit such as 168 with the information stored in cache server 158 may be used. As one simple example, the database 160 may store a record for each asset downloaded into cache server 158. The record could have a field associated with each of the display units in the local area network to receive updates through cache server 158. Cache server 158 may make an entry in this record each time an asset is provided to a display unit. In this way, “new” assets may be identified.

As one synchronization mechanism, the computer within display unit 168 periodically, for example once every thirty seconds, may send a message to cache server 158 requesting a download of any new assets or playlists. Such messages may be sent through the local area network within retail location 150.

However, it is not necessary that each display unit store a local copy of all of the assets. In some instances, it may be desired for multiple display units to display the same assets simultaneously. In that situation, one of the display units may act as a controller unit and the other may act as the controlled unit. The controller unit may contain copies of the assets to be executed. For example, display unit 170 is shown connected to the local area network within retail location 150 through a wireless network interface 166B. Display unit 172 is not connected directly to the network but is connected to display unit 170. Display unit 170 may act as the controller unit and display unit 172 may act as the controlled unit. Controller unit 170 may, as it executes assets according to its playlist, send commands to controlled unit 172 causing it to execute the same assets simultaneously. Alternatively, controller unit 170 may provide a video output to controlled unit 172, thereby directly providing the video to be displayed on the display screen of display unit 172.

It is not necessary that controlled unit 172 display the same information as controller unit 170. In some embodiments, controller unit 170 will execute multiple schedules. One schedule may control the information displayed on the display screen associated with controller unit 170. A second schedule, which may be synchronized with the first schedule, may specify information to be provided to controlled unit 172. As above, the information may be provided in any suitable way, such as by providing the name of the asset to execute, providing a copy of each asset to execute or by providing a direct video signal.

Video display system 100 may include additional devices. For example, portable electronic device 180 is shown within retail location 150. Portable electronic device 180 may access the local area network within retail location 150 through wireless access point 164. In one contemplated embodiment, portable electronic device 180 provides a user interface for local control over the video display system 100 from within retail location 150. Commands entered through portable electronic device 180 may, for example, alter the programming in cache server 158.

Alternatively, commands entered through portable electronic device 180 may control display units such as 168, 170 and 172. As described above, each of the display units contains a computer that has an IP address such that it may receive messages over the local area network within retail location 150. These computers may control aspects of the display, such as its intensity or the volume of sound generated by the display unit. In this way, a person with portable electronic device 180 may move around within retail location 150. While near a display unit, the operator may enter commands to alter display characteristics for that display unit. Preferably messages representing commands are communicated with low latency and each of the display units is programmed to respond to the commands also with low latency. In this way, an operator may receive immediate feedback by observing the operating characteristic of the display.

Portable electronic device 180 may be a PDA, pocket PC or other portable computing device or any portable electronic device equipped with a network interface. The network interface need not be to the local area network within retail location 150. For example, a mobile telephone may communicate over the public mobile switched telephone network to devices and could be used to send commands to devices that can communicate with the mobile switched telephone network.

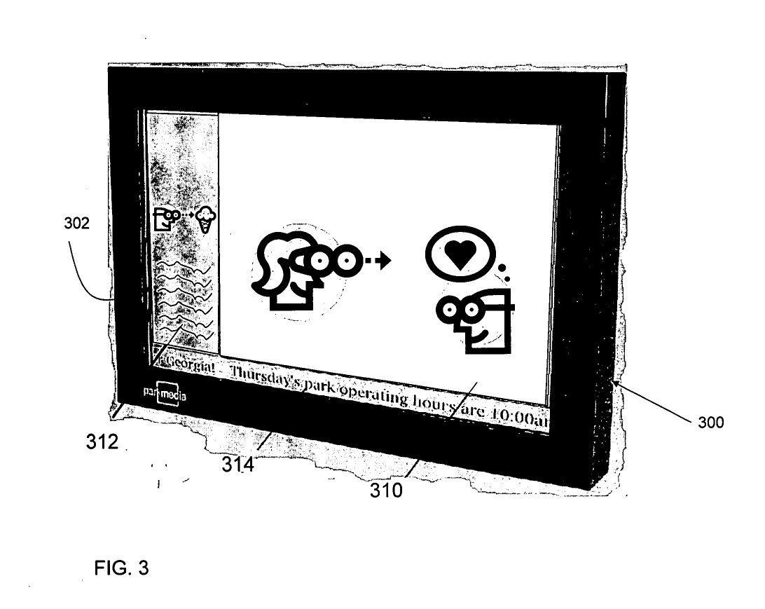

Video display system 100 may also include an operator interface 140 connected through wide area network 130. Operator interface 140 may be a conventional desktop PC, a computer workstation or other suitable operator interface device. Because operator interface 140 is connected through wide area network 130, it may be physically located in any convenient place. In FIG. 1, operator interface 140 is shown to be outside of central location 110 and outside of retail location 150. It is networked to server 112 and cache server 158. Accordingly, user inputs or commands may be communicated through operator interface 140 to server 112 or cache server 158. Further, because each of the display units is connected through a local area network it is possible that data or commands may be sent to or from each of the display units through operator interface 140. In one contemplated embodiment, each of the display units contains multiple display windows, each displaying a different type of data. In this embodiment, operator interface 140 is used to allow different people in different locations to specify the contents of different windows. For example, as described below in connection with FIG. 3, a display unit may include a ticker window 314 displaying text information. Operator interface 140 may create an asset describing the text to appear in a ticker window (314, FIG. 3).

In the described embodiment, operator interface 140 communicates with computers in retail location 150 or central location 110 over the Internet. Likewise the server 112 communicates with devices within retail location 150 over the Internet. Preferably, encryption is used to ensure that unintended third parties do not gain access to the video display system 100. For example communications through the Internet 130 may be by way of an encrypted tunnel (PPTP). However, any suitable security mechanism may be used.

In one embodiment, the assets and the playlists or other control information are communicated through different ports of the devices to provide separate data and communication channels. Device control information may be provided via the HTTP or HTTPS port (typically TCP ports 80 and 443), while assets may be communicated through an rsync port (typically TCP/UDP port 873). In addition, asset transfer and device control may be both secured by tunneling all network traffic through SSH (typically TCP/UDP port 22).

FIG. 1 shows a media database 116 and a scheduling database 118. Two devices are shown to illustrate that multiple types of data are available to server 112. It is not necessary that the information be stored in separate physical media. Preferably, all data is stored in digital form such that multiple types of data may be stored in the same physical media. Furthermore, it is not necessary that there be two databases. Databases containing multiple data tables are known and such a database may be employed to store multiple types of data. Conversely, it may be convenient in some applications to store data in more than two databases. Further, it is not necessary that information be stored in a database at all. Assets may be stored as digital files that can be organized in memory associated with server 112 in any convenient manner.

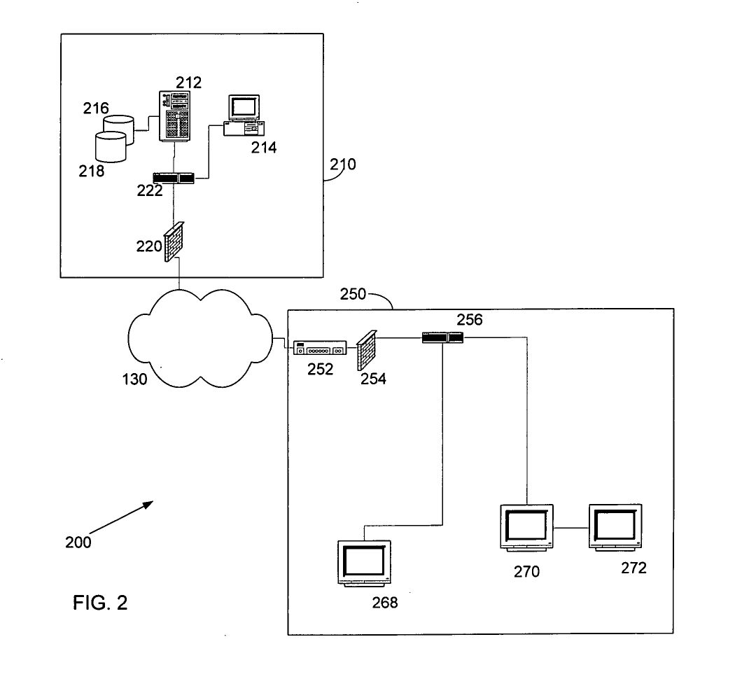

FIG. 2 shows an alternate embodiment of the video display system. Video display system 200 includes a central location 210 and a retail location 250. Central location 210 includes a server 212 that is connected to a media database 216 and a scheduling database 218. Server 212 may be in the same form as server 112 described above. Databases 216 and 218 may be in the same form as databases 116 and 118 described above. In this embodiment, central location 210 includes a switch 222 implementing a local area network within central location 210. Devices within central location 210 may communicate over Internet 130 through router/firewall 220. Therefore, these devices may communicate with the devices in retail location 250.

Operator terminal 214 is connected through switch 222 to the local area network within central location 210. In this way, commands and data entered through operator terminal 214 may be provided to server 212. As in video display system 100, operator terminal 214 allows an operator to upload video assets or specify scheduling of assets for display units at one or more retail locations 250.

Additionally, operator terminal 214 may retrieve status information from the display units in one or more retail locations 250. Status information may, for example, be in the form of log files recording assets executed by those display units. Display terminal 214 may present this information directly to a user or may process one or more reports for the user. Such information need not be provided directly to a human user. It may, for example, be used in an automated billing system to generate bills to advertisers whose content was content was displayed on the display units within retail location 250. Alternatively, status information may be used to generate royalty payment reports needed to pay royalties to content providers whose content was displayed in the display units within retail location 250.

The local area network created by switch 222 is connected through router/firewall 220 to the Internet 130. Internet 130 acts as a wide area network allowing the computerized equipment within central location 210 to communicate with computerized equipment within retail location 250. Retail location 250 includes a modem 252, such as a DSL modem. Modem 252 provides a connection for the local area network within retail location 250 to the Internet 130.

Router/firewall 254 connects modem 252 to a switch 256. Switch 256 in turn makes connections to one or more display units such as 268 and 270 within retail location 250. As described above, each of the display units such as 268 and 270 includes a computer processor and a network interface. Each computer processor is assigned an IP address such that messages may be exchanged between server 212 and each of the display units such as 268 and 270. Further, IP addressing allows messages to be exchanged between the computer processors in the display units connected to the local area network.

In the example shown in FIG. 2, the display unit 268 and display unit 270 are shown connected in a local area network. In contrast to the local area network of FIG. 1, FIG. 2 illustrates a hard wired local area network. Connections between each of the display units and switch 256 may be implemented with CAT-5 cabling, fiber optic cabling or any other suitable media.

In the illustrated embodiment, display unit 272 is shown connected to display unit 270. No separate connection to the local area network is shown for display unit 272. In this configuration, display unit 272 receives display information from display unit 270. Display unit 272 is a controlled unit and display unit 270 acts as the controller unit in the same way that display unit 172 is a controlled unit and display unit 170 is a controller unit.

In the configuration of FIG. 2, retail location 250 does not include separate cache server hardware comparable to cache server 158 shown in FIG. 1. Each display unit such as 268 or 270 may contain a general purpose computer processor and memory for storage of digital information. Accordingly, any of the display units may perform the same functions as cache server 158 and associated database 160. In the embodiment illustrated in FIG. 2, the computer processor within display unit 268 serves as the cache server for display units within retail location 250.

It is not necessary though that retail location 250 include any cache server. Information on scheduling and assets may be provided directly from server 212 to each of the display units, such as 268 and 270.

Turning to FIG. 3, an example of a display unit 300 is shown. Display unit 300 includes a display screen 302. Display screen 302 may be segmented into multiple windows. In the embodiment of FIG. 3, three display windows are shown. As described above, display unit 300 has a computer processor associated with it. Computer processors that generate display information for multiple windows on a display screen are known. The contents for each window on screen 302 may be generated by the processor within display 300 executing one of the assets.

In the example of FIG. 3, display screen 302 is divided into three windows, main window 310, billboard window 312 and ticker window 314. In the illustrated embodiment, main window 310 has an aspect ratio suitable for displaying a video clip. Billboard window 312 has an aspect ratio suitable for displaying a still image. Ticker window 314 has an aspect ratio suitable for displaying a line of text. The processor within display unit 300 may generate information for each of these windows by executing an asset. For example, the content for main window 310 generated by executing an MPEG file. Content for window 312 maybe generated by executing a JPEG file. Content for ticker window 314 may be generated by executing a PERL script that scrolls text in ticker fashion through ticker window 314 or by running a JAVA program that scrolls HTML markup or graphic content through ticker window 314.

Information in each window may be coordinated to provide significant flexibility in the display of information through the video display system. For example, FIG. 3 illustrates an animated video clip displayed in main window 310. Characters from that animated clip may appear in a still image in billboard window 312, which may display an advertisement for ice cream or some other product.

The playlists for the assets in each of the windows may be synchronized so that content in the separate windows is synchronized. A simple way to synchronize the execution of assets is to create playlists that execute in the same amount of time. For example, if a video clip displayed in main window 310 will execute for 30 seconds, the playlist for billboard window 312 may specify that a still image to be synchronized to the video be displayed for 30 seconds. Multiple assets may also be synchronized. For example, if a video clip displayed in main window 310 executes in 30 seconds, the playlist of billboard window 312 could specify a series of assets that collectively execute in 30 seconds. As a specific example, the playlist for billboard window 312 could have a still image displayed for 10 seconds, an HTML file for 15 seconds, followed by a Flash animation for 5 seconds.

Turning to FIG. 4, a user interface 410 is illustrated. User interface 410 may be presented to a user through operator terminal 114 or 214 as illustrated in FIGS. 1 and 2. User interface 410 includes control constructs as are traditionally used in graphical user interfaces. These controls allow a user to associate a group of assets with a specific display area for a specific group of devices.

User interface 410 includes a menu bar 412. Menu bar 412 provides a means for a user to access any of the primary functions of the user interface.

List window 414 displays information in a hierarchical fashion. Controls 420, 422, and 424 control which type of information is displayed in list window 414. In the embodiment illustrated in FIG. 4A, control 420 has been selected such that playlist schedules are displayed in list window 414.

In this example, playlist schedules have been organized into three groups: those for billboard display areas such as 312, those for a main display area such as 310 and those for a ticker display area such as 314. Multiple playlist schedules may be created within each type. For example, FIG. 4A shows playlist schedules “Now Playing” and “Starting Jun. 5, 2004 12” created under the category of billboard display area. A user may wish to create multiple playlist schedules to allow different playlists to be specified for different devices or groups of devices. Alternatively, multiple playlists may allow different playlists to be specified for the same groups of devices at different times. Multiple schedules may be provided to allow rapid changes of the content scheduled to be displayed at groups of display units.

Each playlist schedule provides a mapping between video display units and specific playlists. Playlist schedules may be created, but are not effective until a user operates a command under the publish heading in menu bar 412. Invoking the publish command causes the user interface server 112 to send playlists to each video display unit for which a playlist is specified. In a contemplated embodiment, only “new” playlists will be transmitted. In this way, playlists are only transmitted when they are different than the playlist previously published.

FIG. 4A also illustrates how a user may specify the relationship between device groups and specific playlists needed to create a playlist schedule. In list window 414, the “Now Playing” playlist schedule under the billboard display area heading is shown selected. Accordingly, this playlist schedule is located in drill down window 416. Drill down window 416 shows that multiple device groups are created for video display system 100. In this example, the device groups are identified as “All Devices,” “Memphis,” and “San Francisco.” Each device group has associated with it a control that allows further detail in the hierarchy to be revealed or hidden. The device groups for Memphis and San Francisco are shown with the detail revealed. The Memphis device group is shown to have associated with it a playlist called “Park Media Office.”

The playlist Park Media Office is shown highlighted in drill down window 416. Highlighting a playlist in drill down window 416 causes details of that playlist to appear in drill down window 418.

Drill down window 418 shows details of playlist “Park Media Office.” Each playlist consists of a series of assets. Here the playlist “Park Media Office” is shown to include two assets: “Cosmic Ray's Starlight Cafe” and “Next Bus Banner.” Accordingly, when the Now Playing playlist schedule is published, the display units in the device group identified as “Memphis” will receive a playlist that causes the processor associated with those devices to first display within the billboard display area 312 an image corresponding to the asset entitled “Cosmic Ray's Starlight Cafe.” Such an image may, for example, be an advertisement for a restaurant. The processor within the display unit will alternately display this image with information generated by the web application entitled “Next Bus Banner.” This web application may, for example, retrieve information about bus schedules or arriving in departing buses from a web server and display that information in billboard window 312.

User interface 410 allows a user to change the playlist, device groups, or playlist schedule by using the controls on the user interface. For example, drill down window 418 includes a control 426 that allows a user to add assets to the playlist. Control 426 appears in connection with a window displaying the playlist entitled “Park Media Office.” Accordingly, operating control 426 with the user interface in the configuration shown in FIG. 4A will initiate a wizard that allows assets to be added to the playlist entitled “Park Media Office.” Steps in operating that wizard are illustrated in FIGS. 4B, 4C and 4D.

FIG. 4B shows a wizard window 440A. A wizard window 440 may, for example, appear superimposed on the user interface 410 (FIG. 4A). As is known in the art, a wizard is a program that walks a user through series of steps required to perform a specific function. Wizard window 440A shown in FIG. 4B is the first step in the process of adding an asset to a playlist. In the step illustrated in wizard window 440A, the user is presented with a choice of creating a new asset or selecting an existing asset. Once the user makes a choice, the user may move to the next step in the process controlled by the window by operating the control 442.

FIG. 4C shows a wizard window 440B representing the next step in the process for adding an asset to a playlist when the user has elected to add an existing asset. In wizard window 440B, a user may specify an asset type. In the illustration of FIG. 4C, the user has specified an asset type of MPEG2 video. Specifying an asset type causes a list of all assets of that type already created to appear in list window 444. The user may high light in list window 444 one of the assets. When a specific asset is selected, a user may then move to the next step in the wizard which is illustrated in FIG. 4D.

When a user indicates through wizard window 440A that the user wishes to create a new asset, the wizard window displayed would be in a different form than shown in FIG. 4C. The wizard window for creating a new asset would guide the user through identifying the asset and providing it with a name such that it could be referenced by the video display system. As described above, assets may be digital files. Identifying the asset may include specifying the location of a the digital file so that it later may be accessed or loaded into a server, such as 112. Other information on the asset may also be gathered. For example, the owner of the asset may be recorded and stored in a database such as database 118 to facilitate payment of royalties.

FIG. 4D shows wizard window 440C. Assets in the playlist appear in list window 448. Wizard window 440C allows the order of the assets in the playlist to be changed. By highlighting an item in list window 448 and operating the controls 446, a user may move a particular entry up or down in the playlist. Upon completion of the ordering of the playlist through wizard window 440C, the user may select to finish the wizard, returning control to the user interface 410 as shown in FIG. 4.

When the user has completed changes with the playlist, the user may elect to apply those changes by using control 430. When control 430 is operated, each playlist schedule including the modified playlist is updated to include the new playlist. When that playlist schedule is next “published,” the new playlist will be provided to each display device scheduled to execute that playlist.

Other controls in user interface 410 allow the user to perform other functions that specify the scheduling of assets on devices throughout the video display system 100. For example, control 428 allows a user to highlight an asset in a playlist appearing in drill down window 418 and remove that asset from the playlist.

Similar wizards and control functions allow a user to specify information about devices, device groups or assets. For example, by activating control 422, user interface 410 would reconfigure to display in list window 414 information on devices. Information may be sorted by device group, device type, device location or in any convenient way. User interface may contain controls (not shown) that specify the criteria for grouping devices on the display.

When list window 414 is configured to display devices organized by device groups, selecting a device group from list window 414 may cause a list of devices in that group to appear in a drill down window such as 416. Such a drill down window may include controls corresponding to the add asset control 426 or remove asset 428 controls associated with a playlist. Such controls in connection with a device group drill down window would allow devices to be added or removed to each device group. Likewise, selecting the add device control may invoke a wizard walking the user through the steps of selecting a device. Such a wizard may walk the user through the steps of identifying a device to the group.

Other wizard screens may guide a user through the process of identifying a new device to the system. For example, FIG. 4E shows a wizard screen 440D such as may appear while a user is entering a new device. Wizard screen 440D contains fields to collect information about the device. In the example of FIG. 4E, a device is specified by providing such information as s device name, the type of device (e.g. a 30″ LCD display, a 19″ LCD display, a 42″ plasma display, etc), the size of the device (in pixels) and a location for the device. As described above, each device may be accessed through an IP address. Wizard screen 440D also shows fields from which an IP address for the device may be determined. In this example, the information is provided in the form of a “Host String.” In one particular example, each video display unit is provided with an IP address within a private class C address space subnetted as a class B address to allow for the necessary number of addresses and the information provided through the wizard allows such an IP address to be determined for the device.

Likewise, assets may be managed through user interface 410. For example, activating control 424 may cause a list of assets to appear in list window 414. Assets may be grouped by asset type, asset owner or in any convenient manner. Wizard screens may also allow the creation of new assets. As described above, assets may be stored as digital files that may be executed and the wizard may guide the user through the process of identifying the file to use as an asset. Wizards may allow assets to be created in other ways.

For example, the file specifying an asset to display text in ticker window may be a small amount of HTML code. A wizard may guide a user through the process of inputting the text needed to create a text banner asset. FIG. 4F shows a wizard window 440E that contains a field in which a user may enter HTML code that is displayed in a ticker window. Other windows in the wizard may then guide the user through the process of providing a name and other information about the asset.

The user interface illustrated in FIGS. 4A through 4F is one example of the manner in which content may be scheduled on a plurality of display units throughout the video display system 100. Any suitable mechanism may be used.

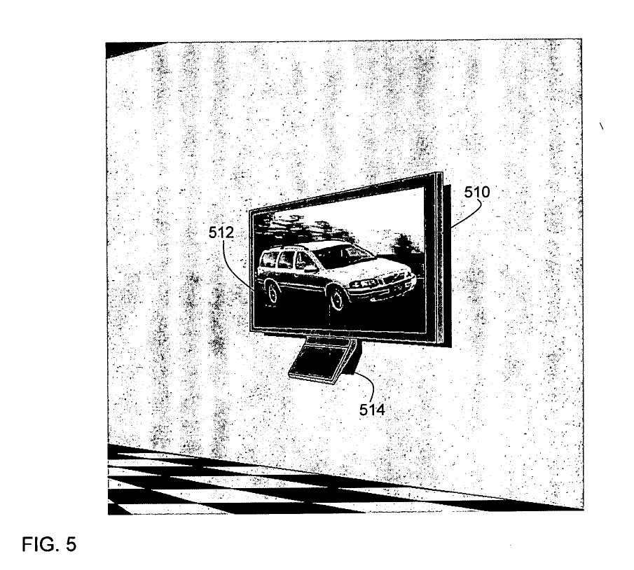

Turning to FIG. 5, an alternative embodiment of a video display unit is shown. FIG. 5 shows a display unit 510 containing a large display screen 512. Display screen 512 may be segmented into multiple windows as illustrated above in connection with display unit 300. However, in the example of FIG. 5, a single window is shown on display screen 512. Contents of display screen 512 may be scheduled with a playlist as described above. Further, display unit 510 may be connected to other display units or a cache server over a local area network in the same way that display units are connected to a network in the embodiment of FIG. 1. Alternatively, display unit 510 may be connected over a wide area network to a central server 212 such as illustrated in the embodiment of FIG. 2. Alternatively, a playlist and assets may be loaded into display unit 510 in any convenient manner. In use, display unit 510 may play assets on display screen 512 according to a playlist. The playlist may be created by a user according to the process explained above in connection with FIGS. 4A-4F.

In the embodiment shown in FIG. 5, display unit 510 includes a user interface device allowing user input that would suspend execution of assets according to the playlist. In the embodiment shown, the user interface is a touch screen 514. In one contemplated embodiment, touch screen 514 displays a menu of alternative assets. When a user selects an alternative asset by making a selection through touch screen 514, the processor within display unit 510 suspends display resulting from the execution of assets according to the playlist and displays the results of execution of the asset specified by the user input.

Such a system provides for flexible advertising. As a result, systems according to the invention may be well suited for providing digital signage for advertising. The playlist may for example, cause display unit 510 to present a general description of a product. The display resulting from execution of the playlist may provide an eye-catching display. Assets that may be selected by the user through the touch screen may provide additional details for interested customers. The choices presented to the user through touch screen 514 may be static or may alter dynamically as the display on screen 512 changes. The menu displayed on touch screen 514 may be generated by executing an asset. In one contemplated embodiment, the menu is generated by an asset that is an J2EE web application.

As described above, playlists for different display units or different windows in a display unit may be synchronized. Also, it is not necessary that the assets in a playlist provide video images. Any executable file may be an asset. Accordingly, the display unit 510 may receive separate playlists to control the display screen 512 and touch screen 514. The assets in the playlist for touch screen 514 may contain executable instructions that cause touch screen 514 to present an appropriate menu of choices to the user. By synchronizing the playlist for screen 512 and touch screen 514, the menu choices on touch screen 514 may be synchronized to the video images on display 512.

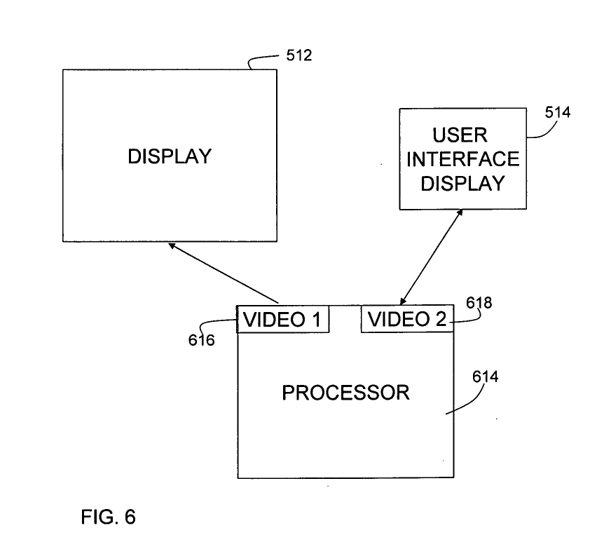

Turning to FIG. 6 a block diagram of display unit 510 is provided. A computer processor such as processor 614 is included in the unit. In this example, processor 614 includes two video cards 616 and 618. Video card 616 drives a main display such as 512. Video card 618 drives the user interface display, such as the touch screen 514 illustrated in FIG. 5. Processor 614 may execute playlists for display 512 and user interface display 514 simultaneously, resulting in appropriate information appearing on screens 512 and 514.

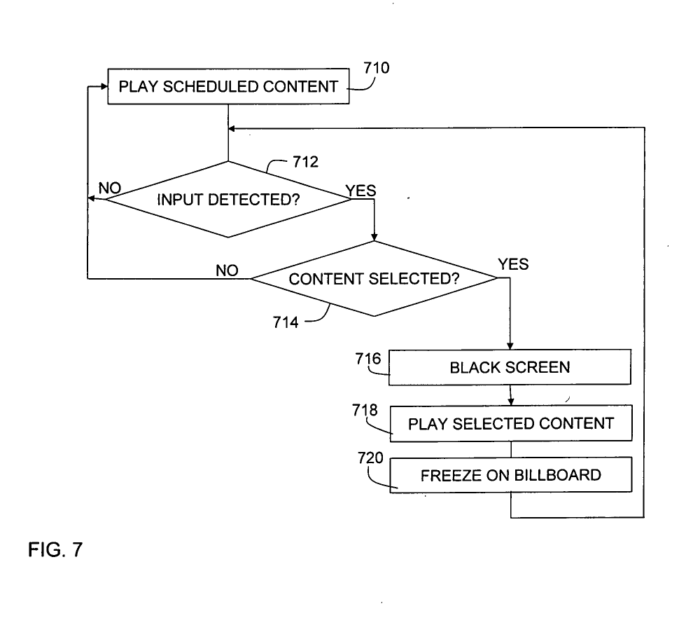

FIG. 7 illustrates a flow chart of a process by which a display unit such as 510 may operate. The process begins at block 710. In the absence of user input, display unit 510 plays content scheduled according to a playlist provided to it. At decision block 712, a check is made for input through the user interface device. If no user input is detected, the process moves back to block 710 and the display unit 510 continues playing scheduled content. If user input is detected at block 712, a check is made at block 714 whether the input specifies content to be displayed by display unit 510. If no content is specified, the process continues with schedule content being played at block 710.

When a content selection is detected at block 714, the process proceeds to block 716. At block 716, the display screen such as 512 is momentarily blanked. Block 716 provides a transition from scheduled content to user selected content. Blanking the screen may improve the user's experience by providing immediate visual feedback of an input, but is not necessary to operation of the device.

The process proceeds to block 718. At block 718 the assets specified by the user input is executed. Once the selected asset is executed, the process proceeds to block 720. At block 720 the processor 614 sets the display on screen 512 to momentarily display a still image. For example, the still image may be an image of the product being advertised. The process of block 720 provides the user with a visual indication that the display of user-selected content is completed. Freezing the screen on a still image for a short period of time, such as approximately 20 seconds, also allows the user time to provide additional input.

At the end of the delay introduced by block 720, processing proceeds back to decision block 712. At decision block 712 a check is made for additional input from the user. If no additional input is detected, the processing proceeds at block 710. At block 710 the display of content according to the playlist is resumed. In this embodiment, processor 614 tracks progress against the playlist even as user selected content is displayed by block 718. Accordingly, when user selected content is completed, processor 614 may display content from the playlist according to the schedule established by the playlist as if no interruption had occurred. Where multiple display units are included in the same retail location, this mechanism allows the display to stay synchronized while not displaying user selected content. In alternative embodiments, processor 614 may record the stopping point in the play list and resume from that point.

Where input is detected at block 712, the process continues to block 714 to determine whether a user selected additional content. If the user selected content, processing again proceeds to blocks 716, 718, and 720.

The process of FIG. 7 is illustrated in connection with a display system in the form shown in FIG. 5. However, it is not necessary that the user input device be a touch screen. Users may provide input through a keyboard, a mouse or other computer peripheral. The interface device also need not be an integral component of the display system. A portable electronic device may be connected through a wireless link to the network on which display unit 510 is connected. A mobile telephone or similar device may serve as a user interface. For example, if the processor in display unit 510 has an SMS address, user input might be sent from a mobile telephone, pager or similar device as text messages or other electronic content.

Alternatively, input need not be provided by an affirmative act of the user. For example, the user interface device may be an RFID reader. The RFID reader may read information from an RFID tag affixed to products in a store. The RFID reader would then detect products carried near the display unit. By sensing that a customer has a particular type of product near the display unit, the display unit may provide information about that product. Alternatively, the display unit may provide information or advertisement for products used in conjunction with that product. As one example, the display unit may be used in a video rental store. The display unit may detect that a customer has carried a video case tagged with an RFID tag near the display unit. Upon detecting an RFID tag identifying a particular movie, the display unit may execute an asset containing a trailer for that movie.

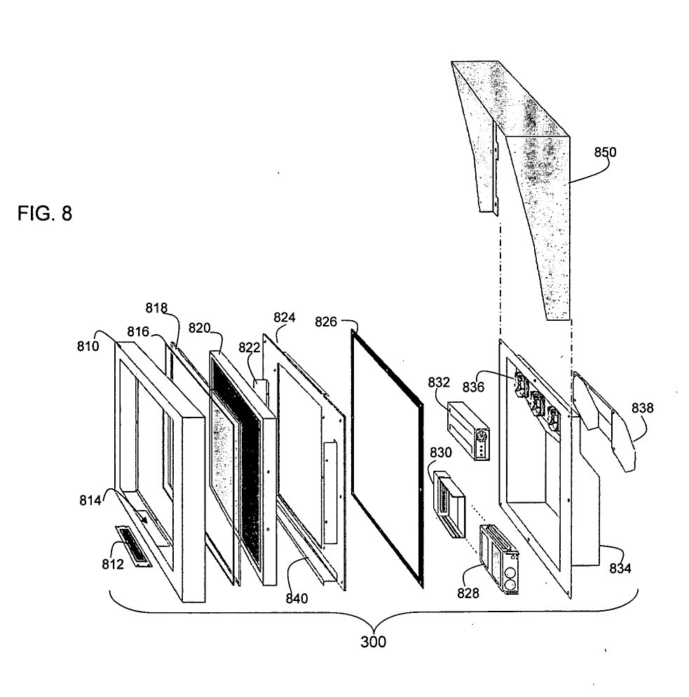

FIG. 8 shows an exploded view of a display unit 300. The size, shape or construction of the unit used in a video display network according to the invention is not critical. The video display unit 300 shown in FIG. 8 is suitable for use in an outdoor environment. For example, video display unit 300 may be used in a retail location 150 that is an amusement park.

Display unit 300 includes a display panel 820. In the illustrated embodiment, display panel 820 is an LCD panel. Preferably, the display panel is at least 19 inches in diagonal. In outdoor environments larger panel sizes may be preferred. For example, panel sizes of 21 inches, 23 inches, 30 inches or larger may be used. Also, the display panel need not be an LCD panel. A plasma display panel may alternatively be used.

Display 820 is held within mounting brackets 822 on mounting plate 824. Mounting brackets 822 and mounting panel 824 may be made from metal or any suitably rigid material.

Shield 818 is placed over display panel 820. Shield 818 is a clear sheet to protect display panel 820. Shield 818 may be tempered glass with an anti-UV or reflective coating. Alternatively, Plexiglas or other suitably strong, clear material may be used.

Display 810, together with mounting plate 824 and shield 818, is pressed into bezel 810. Bezel 810 may be formed of sheet metal or any other suitably rigid material.

Gasket 816 is positioned around the perimeter shield 818 and is positioned to be between shield 818 and Bezel 810. Gasket 816 may be made of any suitably soft and weather-resistant material, such as materials containing silicone or rubber.

Bezel 810 has a vent hole 814 formed in a lower surface. Vent hole 814 is covered by a vent cover 812. Vent cover 812 is a perforated member allowing air to pass through. Vent hole 814 forms a portion of the cooling system inside display unit 300. It allows air to circulate through the unit, but is shielded to prevent water from entering the unit. When mounting plate 824 is inserted in the unit, baffle 840 prevents any water entering through vent opening 814 from reaching the electronics inside display unit 300. Baffle 840 is shaped to allow air to flow through vent hole 814 into display unit 300.

The rear of display unit 300 is formed by pan 834. Pan 834 may be constructed of sheet metal or other suitably rigid material. To assemble the display unit 300, pan 834 is secured to mounting plate 824, such as with screws, bolts or other fasteners. Gasket 826 provides a weather tight seal between mounting plate 824 and pan 834. Gasket 826 may, like gasket 816, be made of a siliconized or rubberized material.

Pan 834 is shaped to provide a cavity in which the computer processor for display unit 300 may be installed. FIG. 8 shows that a power supply 832 is mounted within the cavity formed by pan 834. Likewise, a processor unit 828 is mounted within the cavity formed by pan 834. In the illustrated embodiment, a computer dock 830 is installed within pan 834. Processor unit 828 slides into dock 830, allowing connectors on dock 830 to engage connectors on processor 828. In this way, processor 828 may be easily installed or removed in a display unit 300, allowing the same type of processor to be used with any types of display to which a dock may be connected.

Wiring between the components within pan 834 is not expressly shown. However, one of skill in the art will appreciate that wires connect power supply 832 to dock 830. In addition, cabling will connect dock 830 to a video input to display 820. Further, a network connection will be present for processor 828, which also is not expressly shown. A network connection may be in the example of a wireless local area network shown in FIG. 1, an 802.1b wireless module connected to a PCI or USB port in processor 828.

Processor 828 may include a hard drive, such as a 40 GB hard drive. In addition, other 10 devices may be connected to computer 828. For example, speakers may be connected to processor 828 either directly or through an audio amplifier. Likewise, in the event that display unit 300 includes a user interface such as touch screen 514 (FIG. 5), such user interface devices may also be included in display unit 300.

Processor 828 is programmed with software to control the functions described above. Such functions may include: receiving one or more playlists and assets; receiving updated playlists and assets; executing the assets according to the playlists; generating the appropriate display information in the desired regions of the display; making a log of asset execution; and transmitting the log to the appropriate server. Creating software for such functions is within the skill of those in the art. For example, processor 828 may be built around a commercially available Intel processor and programmed with a commercially available operating system, such as Linux. Execution of assets may be readily accomplished by commercially available programs, sometimes referred to as “plug-ins,” that are readily integrated in the software for such processors.

Display unit 300 may also include a hood 850. Hood 850 may be constructed from any suitable rigid material, such as sheet metal. It is attached to pan 834 and provides shielding of display 820 from sunlight.

Display unit 300 may also include a cooling system. Such a cooling system may be desirable for display units operated in outdoor locations, particularly those in warm climates. In this example, the cooling system is an air cooling system. Fans 836 circulate air through vent 814, resulting in air flow over the electronic components in pan 834. Fans 836 exhaust air out the rear of pan 834. Cover 838 prevents rain or other water from entering the display unit 300 through the exhaust openings.

Alternatively, other forms of cooling systems may be used. For example, cooling systems based on Peletier units may be employed.

Additionally, display unit 300 may include an adaptive volume control. In this embodiment, display unit 300 may include a microphone or other device to sense sound levels. The microphone may provide input to processor 828 or other electronic circuitry allowing that circuitry to determine ambient sound levels. The volume of speakers, if included in display unit 300, may then be adjusted by processor 828 or other processing circuitry in proportion to ambient sound levels.

The system described above provides significant flexibility in scheduling assets on many devices. Alternative user interfaces may be provided to facilitate use of this flexibility. As one example, it was described above that each display unit may have multiple display windows and that each display unit may be controlled by a playlist. FIGS. 4A-4F illustrate a user interface by which a user may specify playlists that result in synchronized content in the windows in each display unit. In some instances, a user may prefer to specify assets that are to be executed together without synchronizing playlists for different display windows.

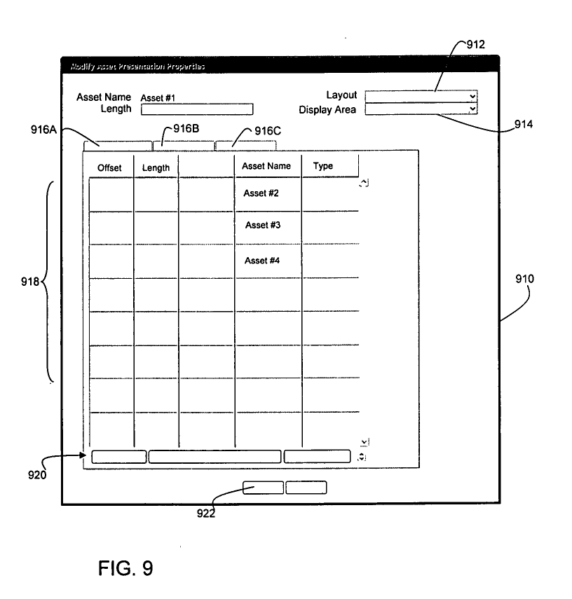

FIG. 9 shows an interface window 910 that may optionally be used to allow a user to “pair” assets. When an asset that has been “paired” with other assets is executed, the display unit executing that asset also executes any paired assets in other display windows.

In FIG. 9, window 910 is configured for pairing assets with an asset named “Asset# 1.” Herein, Asset# 1 is referred to as a dominant asset because the scheduling of that asset will drive the execution of the paired assets.

Fields are provided for information about the dominant asset, such as a field for the length of the asset. Window 910 also includes drop down list box controls to allow a user to indicate the layout of the device on which the dominant asset will be displayed and the display area in which the dominant asset is to be displayed when the pairing applies. List box 912 may be used to select the layout and list box 914 may be used to select the display area. In the example of FIG. 9, the pairing applies when Asset# 1 is displayed in the main display area of a display type such as is shown in FIG. 3.

Window 910 includes multiple tabbed areas 916A, 916B and 916C. Each tabbed area corresponds to one of the display areas in the layout indicated in dropdown list box 912 that might be synchronized to the display area selected in dropdown list box 914. In the example of FIG. 9, tabbed area 916A is visible. Tabbed area 916A may, for example, correspond to a billboard display area.

Tabbed area 916A contains a list 918 of assets to be displayed in the billboard display area when Asset#1 is displayed in the main display area. In this example, list 918 specifies that Assest#2, Assest#3 and Assest#4 should play, in that order, when Asset#1 is displayed in the main display area.

Window 910 includes a group 920 of controls that allow a user to perform such functions as adding assets to list 918, deleting assets from the list, changing the order of assets in the list or otherwise altering properties of the assets in the list. List 918 may be thought of as a “paired playlist” and any operations that are performed on a playlist may optionally be performed on list 918.

Similar pairings may be specified in other tabbed areas. Pairings for the ticker display window may be specified in tabbed area 916B. Additionally, a pairing may be specified for an “audio window.” In the embodiment illustrated, the display unit has speakers and a playlist may specify audio assets. Entries in each tabbed area may create paired playlists for each of the display areas of the display unit.

A control such as 922 allows the user to apply the pairing specified in tabbed areas 916A, 916B and 916C. When the pairing is applied, the pairing information is stored in a scheduling database, such as database 118. The pairing information may then be provided to display units. Pairing information may be provided in any suitable manner. For example, pairing information may be provided using the same communication channels as are used to publish playlists to display units. Pairing information may be provided to all display units when published or may be provided selectively only to those devices receiving playlists in which the dominant asset appears.

The display unit stores information about the dominant asset and the pairings. When the dominant asset is executed in the specified window, the display unit then executes any paired playlists for the other display areas. If a display area is already executing a playlist when the dominant asset begins to execute, that playlist is interrupted. When execution of the dominant asset is finished, the display unit resumes execution of the playlists for each display area. The playlists may resume at the point where they were interrupted or may resume at the point they would have reached had they not been interrupted to execute the paired playlist.

In this way, synchronization may be readily provided within windows of a display unit. This concept need not be limited to pairing of assets executed on the same display unit. The pairing concept may be extended to pairing of assets executed on different display units. As described above, the video display system may be constructed such that display units are connected to a network, allowing messages to be transmitted between display units. When a dominant asset is executed on one display unit, it may send a message to other units, containing paired display windows, to execute paired assets in those windows.

Users may also prefer to schedule content so that different content is displayed at different times. A user could publish new playlists to change the content presented by a device whenever desired. However, the user interface may optionally be implemented to facilitate scheduling of assets.

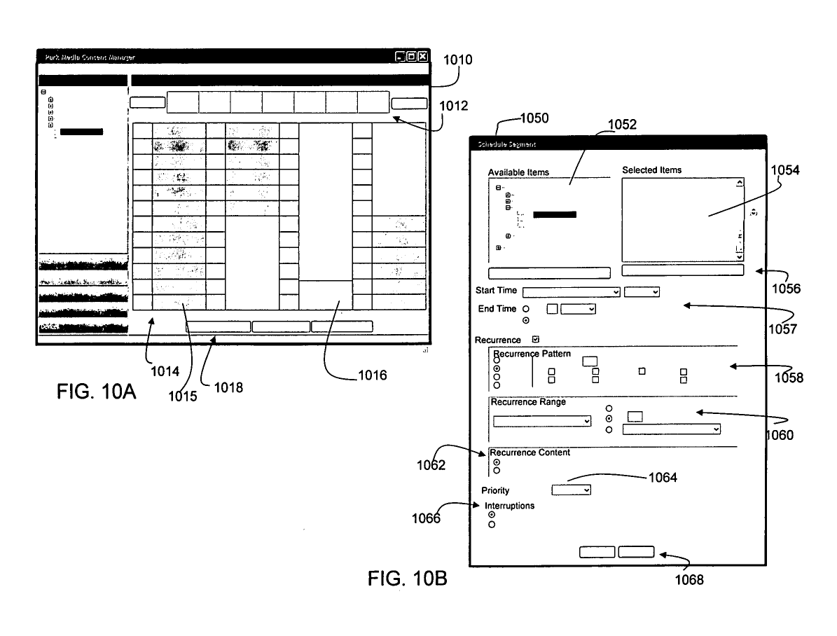

FIG. 10A illustrates a user interface 1010 that allows scheduling. In this embodiment, scheduling is performed on “segments.” A segment is a group of playlists specifying the actions of a display unit or a group of display units at one time. For example, a segment for devices having three video windows may consist of three playlists, one for each video window. User input screens to facilitate the user grouping playlists into segments may be provided, but segments may be specified in any suitable manner.

User interface 1010 provides a graphical representation of time slots in which segments may be scheduled. Field 1012 allows a user to specify a specific day. Here, field 1012 is shown to contain seven subfields, each allowing a user to specify a day in any seven day period. Field 1012 may have controls associated with it to allow a user to specify which seven day period is displayed in field 1012.

When a day is selected in field 1012, a timeslot schedule for the selected day is displayed in field 1014. Field 1014 is shown segmented into multiple time slots 1015. Here, each time slot 1015 is shown to be 30 minutes long, but time slots of any desired length may be used.

When segments are specified to be executed in certain time slots, they are said to create a content block. User interface 1010 includes a group 1018 of controls that may be used to add or delete content blocks. Controls within group 1018 may also be used to modify the parameters specified for any content block. When a content block is scheduled, an indicator 1016 is added to the timeslot schedule displayed in field 1014.

When a control is activated to add or modify a content block, a separate user interface may be presented. FIG. 10B provides an example of a user interface window 1050 that may be displayed when a user wishes to add or modify a segment.

Window 1050 contains a window 1052 in which segments available for programming are displayed. Segments may be displayed hierarchically or in any other suitable fashion. Controls 1056 are added to allow a user to select or de-select segments for inclusion in the content block. Selected segments may be identified to the user in any convenient means, such as by listing them in window 1054.

Window 1050 includes a group 1057 of controls to allow the user to specify the start and end of the content block. Any suitable control interface may be used. For example, drop down list boxes may be provided to allow a user to select the start time of the content block. The content block may end once the segments selected for the content block are executed. Alternatively, controls may be provided to allow the user to specify an end time to the content block. In this scenario, display units may be programmed to respond to situations in which the segments in the content block either are executed before the specified ending time or are still executing when the specified ending time is reached, such as by looping through the scheduled segments but interrupting execution of the segments at the specified ending time. As a further alternative, the system may be capable of determining the end of a content block in either fashion and the user could be given the option to specify the ending time of the content block or to allow the system to determine the end of the content block based on the length of the segments programmed into that content block.

Window 1050 may also contain a group 1058 of recurrence controls. Recurrence controls may create multiple copies of the same content blocks at a specified frequency. For example, the recurrence controls may specify recurrence at a frequency that may be daily, weekly, month, etc. Window 1050 may also include range controls 1060 that allow a user to specify the length of time for which the recurrences should be scheduled. The range may be specified based on an ending date or may be specified based on some number of recurrences. Regardless of the specific manner used to specify the range, when a content block is scheduled with a recurrence, the server providing the user interface may enter in the schedule multiple copies of the content block at the recurrence frequency throughout the recurrence range.

Window 1050 further includes a group 1062 of controls that specify actions for each recurrence of the content block. For example, one control in the group may specify that the exact same content is executed for each recurrence. Alternatively, a control may specify that the system check for updates to each asset in the content block for each recurrence. Such a feature may be useful, for example, when assets are generated automatically based on a set of business rules. For example, an asset that displays a menu for a restaurant may be generated by a script that reads a database of menu items for that restaurant and converts it to HTML. In this case, it might be desirable to regenerate the asset for each recurrence of the content block to ensure that the menu items and prices are accurate when displayed.

Window 1050 may also include a priority field 1064. Here, field 1064 is shown as a dropdown list box, allowing a finite number of ordered choices. As has been described herein, the user is provided with multiple methods to specify the assets to be executed in each display area in each display unit. Whenever multiple assets are specified for the same display area of the same display unit, the display unit will execute the highest priority. Priority may be implied. For example, it was described above that paired assets interrupt scheduled assets. Thus, paired assets have an implied priority higher than scheduled assets. However, the system may allow a user to specify a priority of assets to control whether one asset interrupts another. Here, a priority is specified for the content block and all assets executed within the content block share that priority, but other suitable methods for specifying priority may be used, if desired.

Window 1050 further includes a group 1066 of controls that specify the behavior of the display unit when the content block interrupts execution of another playlist. Options may include resuming the prior playlist at the point of interruption or resuming the playlist at the point at which it would have been playing had it not been interrupted.

Further, window 1050 includes a group 1068 of controls that control whether the information entered in window 1050 is applied. When the information is applied, an indicator 1016 is added. In addition, the user interface server, such as 112, creates entries in scheduling database 118. In operation, the content server, which may be the same physical device as the user interface server, compares the time against the current time and provides playlists to the display units to cause them to execute the content blocks at the scheduled times.

Further, the content server also provides the required assets to the display units so that they are available to the display units to execute at the scheduled times. Various methods may be employed to determine when the assets should be provided to the display unit. In some embodiments, the content server may provide a “configurable event horizon,” meaning that the server compares the assets stored in each display unit with upcoming events scheduled for that unit. From this comparison, the content server determines when the display unit will require new assets. The content server provides the new assets before that time. However, the content server also compares the memory utilization of the assets stored in the display unit to the available memory in the display unit. It does not provide new resources until after assets that would have to be deleted to make room for the new assets are no longer needed.

Having thus described several aspects of at least one embodiment of this invention, it is to be appreciated various alterations, modifications, and improvements will readily occur to those skilled in the art.

For example, examples of the video display system presented in FIGS. 1 and 2 show a central location linked to one retail location. A central location could provide information and control to more than one retail location.

Also, an embodiment was described in which each display unit playlist a playlist is synchronized to a cache server so that the display units contain copies of all assets that may be in their playlists. As an alternative, each display unit could download only the assets that are included in its current playlist.

Further, it was described that assets are provided to a server, such as 112 or 212 by an operator interfacing with the system through an operator terminal. Assets need not be input through an operator terminal. Assets may be downloaded from another computer over a network. Such a capability may be particularly useful when content is generated by one entity and managed by another. For example, a central server such as 112 may be managed by a content management company. Specific content to be displayed may be generated by enterprise operating retail location 150. In this case, assets may reside on computers owned by that enterprise and downloaded into the server operated by the content management company. Such a download may be performed over the Internet or in any other suitable manner.

Also, digital media to be displayed was illustrated by video or other graphical information. Sound is also represented in digital form and assets that generate sound might also be created and scheduled in play lists. For example, sound assets may be created with .WAV files. Upon execution of a sound asset the sound would be driven to the speakers of the display unit.

Such alterations, modifications, and improvements are intended to be part of this disclosure, and are intended to be within the spirit and scope of the invention. Accordingly, the foregoing description and drawings are by way of example only.

1. A digital medium presentation system comprising:
a) a server;
b) a plurality of interface units coupled to the server, each interface unit having one or more audio or video interfaces, a processor and memory;
c) wherein the server is programmed to:
i) receive user input about assets represented as digital information, with at least a portion of the assets describing information to be presented through an audio or video interface in at least portion of the plurality of interface units;
ii) generate a schedule of assets based on the user input; and
d) wherein each interface unit is programmed to store the schedule and the assets and execute the assets in accordance with the schedule.

2. The digital medium presentation system of claim 1 wherein the assets comprise at least one video clip.

3. The digital medium presentation system of claim 2 wherein the assets comprise at least one executable program.

4. The digital medium presentation system of claim 2 wherein the assets comprise at least one J2EE web application.

5. The digital medium presentation system of claim 2 wherein the assets comprise at least one still image.

6. The digital medium presentation system of claim 2 wherein the assets comprise video information formatted as at least one of a Flash, MPEG, JPEG, or .gif file.

7. The digital medium presentation system of claim 1 wherein each interface unit comprises a display screen that may be segmented into a plurality of windows and the schedule of assets comprises a schedule of assets for each of the plurality of windows.

8. The digital medium presentation system of claim 1 additionally comprising a local area network and each of the interface units is connected to the local area network.

9. The digital medium presentation system of claim 8 wherein the local area network is deployed in a retail location of an enterprise.

10. The digital medium presentation system of claim 8 wherein the local area network comprises wireless interconnections.

11. The digital medium presentation system of claim 8 wherein the local area network comprises fiber optic connections.

12. The digital medium presentation system of claim 9 wherein the retail location comprises an amusement park.

13. The digital medium presentation system of claim 12 wherein each interface unit comprises a display screen in an enclosure comprising a cooling system.

14. The digital medium presentation system of claim 8 additionally comprising a wide area network connecting the server to the local area network.

15. The digital medium presentation system of claim 14 additionally comprising a cache server connected to the local area network, the cache server storing copies of assets to be executed by the interface units.

16. The digital medium presentation system of claim 15 wherein each of the plurality of interface units comprises a processor and the cache server is implemented on a processor in one of the plurality of interface units.

17. The digital medium presentation system of claim 1 wherein the server comprises a user interface server, a content server and a database server.

18. The digital medium presentation unit of claim 2 wherein each of the interface units comprises a processor, a display screen and a user input device coupled to the processor, the processor having a video output driving the display screen, wherein the processor is programmed to:
a) display on the display screen in accordance with the schedule video clips that are assets;
b) in response to user input, interrupt display of assets in accordance with the schedule and displaying on the screen an asset specified by the user input.

19. The digital medium presentation system of claim 18 wherein the processor is additionally programmed to resume display on the screen assets in accordance with the schedule upon completion of display of an asset specified by user input.

20. The digital medium presentation system of claim 18 wherein the user input device comprises a touch screen.

21. The digital medium presentation system of claim 18 wherein the user input device comprises an RFID reader.

22. The digital medium presentation system of claim 21 wherein the asset displayed on the screen in response to user input is promotional material for an item correlated with a value read by the RFID reader.

23. An interface unit comprising:
a) a plurality of audio or video interfaces;
b) memory;
c) at least one input;
d) a processor programmed to:
i) receive through the input a schedule of assets;
ii) receive through the input digital files representing assets;
iii) store the schedule and the digital files representing assets in the memory; and
iv) execute digital files in accordance with the schedule to present assets in audio or visual form through a plurality of the audio or video interfaces.

24. The interface unit of claim 23 wherein the processor is additionally programmed to receive a second schedule through the input and execute assets in accordance with the second schedule to concurrently produce an output through at least two audio or video interfaces.

25. The interface unit of claim 23 wherein the plurality of audio or video interfaces comprises a plurality of video windows on a display screen.

26. A method of operating a digital medium presentation system comprising:
a) receiving at a central location a plurality of assets;
b) receiving at a central location at least two schedules of assets;
c) generating at least a first list and a second list from the schedule of assets;
d) providing the first list and the second list to at least one interface unit over a network;
e) providing the at least one interface unit with copies of the assets; and
f) executing assets with the at least one interface unit in accordance with the first list and concurrently executing assets with the at least one interface unit in accordance with the second list.

27. The method of operating a digital medium presentation system of claim 26 additionally comprising creating a log of assets executed for each interface unit.

28. The method of operating a digital medium presentation system of claim 27 comprising transmitting, over the network, to a central location the logs of assets executed for the interface units.

29. The method of operating a digital medium presentation system of claim 28 additionally comprising generating billing information from the logs of assets executed for the interface units.

30. The method of operating a digital medium presentation system of claim 26 additionally comprising:
a) receiving at the central location a revised schedule of assets;
b) generating a revised list;
c) providing the revised list to one or more video display units over the network;
d) providing the one or more video display units with assets in the revised list that were not in the list; and
e) executing assets with the video display unit in accordance with the revised list.

31. The method of operating a digital medium presentation system of claim 26 wherein generating a list comprises generating an XML file.

32. The method of operating a digital medium presentation system of claim 26 wherein each interface unit has an IP address on an IP subnet and providing the list to one or more interface units comprises sending a message to the IP address of the interface unit.

33. The method of operating a digital medium presentation system of claim 26 wherein a cache server is connected to the network and providing the list to one or more interface units comprises storing the list on the cache server and downloading by the interface unit the list from the cache server.

34. The method of operating a digital medium presentation system of claim 26 wherein executing assets with the interface unit in accordance with the list comprises executing the assets to create a display in one window on a video display and the method further comprises executing assets with the interface unit to concurrently create a display in at least one additional window on the video display.
